(19) United States
(12) Patent Application Publication
(10) Pub. No.: US 2017/0320775 A1
(43) Pub. Date: Nov. 9, 2017

(54) METHOD FOR PRODUCING GRANULATED MATERIALS FROM CEMENT COMPOSITIONS

(71) Applicant: SIKA TECHNOLOGY AG, Baar (CH)

(72) Inventors: Christoph KURZ, Endingen (CH); Christian BÜRGE, Schafisheim (CH); Franz WOMBACHER, Jonen (CH)

(73) Assignee: SIKA TECHNOLOGY AG, Baar (CH)

(21) Appl. No.: 15/520,807

(22) PCT Filed: Nov. 3, 2015
(86) PCT No.: PCT/EP2015/075504

§ 371 Date: Apr. 20, 2017

(30) Foreign Application Priority Data
Nov. 7, 2014 (EP) 14192297.1

(51) Int. Cl. C04B 18/02; C04B 24/04; C04B 12/04; C04B 103/00; C04B 103/10

(52) U.S. Cl. CPC C04B 18/021; C04B 24/04; C04B 12/04; C04B 2103/10; C04B 2103/0051

(57) ABSTRACT

A method for producing aggregates from non-hardened cement compositions, in particular from concrete or residual concrete, which method includes adding a) a water-absorbing agent and b) a crystallization deactivator to a non-hardened cement composition and mixing until a granular material has formed. The method allows unneeded residues of still liquid concrete to be converted into a practical product, which can then be reused to produce new concrete compositions. The invention further relates to a granulated cement material that can be obtained according to a corresponding method, to the use of the granulated cement material as an additive for cement compositions, and to additive combinations for cement compositions, which additive combinations include a water-absorbing agent and a crystallization activator.

The present invention relates to a method for producing aggregates and granulates from non-hardened cement compositions. The present invention may particularly be used to process non-hardened residual cement which may be left over after a works order has been completed. More generally, the present invention relates to cement mixtures which have not been used as intended and must therefore be recycled.

The present invention further relates to a product that can be obtained according to the described method, use thereof as an additive for cement compositions or other application, and an additive combination for cement compositions which comprises a water-absorbing agent and a crystallization deactivator, and the use of such additive combinations to produce granulates from hardened cement compositions.

### PRIOR ART

Nowadays, 1% of the concrete produced cannot be used in the way originally intended. For example, the delivered quantity may exceed the requirement as a consequence of miscalculations—it may be that a certain excess was planned as a reserve, or mistakes may have been made when the concrete was mixed—with the result that the concrete produced is not usable in the intended application. Such concrete is normally returned to the concrete factory where it may be put to further use or reprocessed in a variety of ways. For example, standard elements may be made, or the concrete can be spread out, reground after hardening, and then used again. It is also possible to wash the concrete with water, in which process the non-reactive components such as sand are separated from the cement paste. These components may then be reused to produce fresh concrete. The resulting slag and the remaining fine fractions may also be added to the new concrete again as mixing water.

Several years ago, it was also suggested to reuse concrete that was excess to requirements by granulating it. To this end, additives are added to the concrete and transform it into granules which can be reused as an admixture for fresh concrete after they have completely hardened (after about 24 hours).

However, the existing concrete recycling processes described earlier are associated with various drawbacks, which will be explained in more detail in the following text. With regard to the production of standard concrete elements, for example, the need for such elements does not always exist. In many cases, the demand for such elements is significantly less than the supply, and accordingly such reuse is relatively unattractive from a financial point of view. The grinding of hardened concrete entails breaking a cast concrete structure and removing the admixtures contained by filtering according to size, which makes the process as a whole relatively expensive. Moreover, breaking down and grinding concrete requires consuming a relatively large amount of energy and at the same time a considerable amount of dust and noise is generated. All this also makes processing concrete in this way relatively unattractive from a financial point of view.

When the concrete is washed, as is described for example in DE 39 06 645, sand and gravel components are washed out by the addition of water and separated from the other fine cement sediments. The remaining diluted cement suspension is collected in a separate sedimentation tank. The separated sand and gravel components can be reused immediately. The cement can settle out of the diluted cement suspension in the sedimentation tank, and part of the clear supernatant water can then also be reused.

Although the method described in DE 39 06 645 enables gravel and sand components to be recycled, a disadvantage of this process is that the creation of waste in the form of cement is not completely prevented. Moreover, relatively large quantities of water are needed for washing the residual concrete, and a byproduct of the process is generally quite considerable quantities of contaminated water. Only a small fraction of this washing water can be reused for the production of concrete, because this water contains relatively large quantities of dissolved salts and suspended solids, which inhibit the hydration of the cement and consequently have a negative impact on the mechanical strength of the concrete. For this reason, it is also not possible to use the water recovered from this recycling process for producing high-quality concrete, particularly high-strength concrete or pervious concrete. Excess water, which cannot be used to produce new concrete, must be transported away and neutralized, which entails additional costs.

DE 195 18 469 describes a method for reusing residual concrete that includes
a) adding a quantity of a setting retarder for the cement based on a phosphonic acid derivative which is precisely calculated for the quantity of cement, and
b) adding fresh cement in a mixer truck at the end of the desired retardation period so that the ratio of cement in the fresh and old concrete fractions is at least 2:1.

This method makes it possible to keep the residual concrete in the unhardened state overnight, for example, or to keep it sufficiently liquid over the weekend in the mixer truck and to reuse it in combination with new concrete afterwards, thus avoiding waste. However, a disadvantage of this method is that it is relatively complex to carry out. For example, it is necessary to know the exact composition of the residual concrete, the quantity thereof, its workability, the temperature and the time elapsed after mixing so that these parameters can be used to calculate the exact quantity of setting retarder needed to delay setting for the desired time. Moreover, the addition of the fresh concrete and its ratio to the residual concrete must be balanced and controlled precisely to prevent the new concrete created thereby from hardening too slowly. For these reasons, the method described in DE 195 18 469 is difficult to implement in practical use.

JP 2004/276575 describes a method in which the excess concrete is treated with additives which prevent the cement from hardening but allow the residual concrete to coagulate. The coagulated concrete is then dried and solidified, wherein weak bonding forces are formed so that it can be crushed by suitable equipment. The aggregates created in this way can then be separated from the weakly hydrated cement powder and recycled. This system consequently allows the aggregate to be recovered without producing large quantities of wastewater. On the other hand, a disadvantage of the method is that the hardening inhibiting material must be completely separated from the recovered aggregates to avoid retarding the cement hydration in that location when the recycled aggregate is used to produce new concrete, Furthermore, this method also produces waste because the powder fractions that are separated from the aggregates cannot be reused and must be disposed of. Finally, the residual concrete must be allowed to rest for about a week before it is completely dry. Large areas on which the material can be allowed to dry must be available for this long period. These drawbacks also make this method rather unattractive from the financial point of view.

Japanese Utility Model 3147832 describes a material for the treatment of residual concrete which enables excess concrete to be recycled without requiring large spaces or long periods of time for the concrete to harden. The material comprises a superabsorbent polymer in powder or granulate form enclosed in a receptacle made of water-soluble paper. When this material is added to a mixer that contains the residual concrete, the water-soluble paper enclosure dissolves so that the superabsorbent polymer can come into contact with the concrete. After 5 to 10 minutes of mixing, the superabsorbent polymer absorbs some of the water in the residual concrete; a gel is formed which surrounds the cement and other fine particles. The product obtained thereby is a granular material which can be drained from the mixer. The time the granular material needs for hardening is considerably shorter than the time required in JP 2004/276575. Moreover, this method does not produce any substantial waste because the cement particles and the other fine particles are embedded in the same gel network that encloses the aggregates. In this way, all of the concrete material can be transformed into a granulate material and recycled as roadbed filling material, for example.

The method described in JP 3147832 features significant advantages over the methods described earlier, but this method too has deficiencies. For example, while the superabsorbent polymer absorbs a substantial proportion of the free water immediately after it is added, some of this water is released from the superabsorbent gel over time, so the granular material may become wet and sticky again and tend to re-agglomerate. If the material is not mixed in the mixer for a prolonged period, granular material is no longer produced and the concrete mass may form long, stiff blocks, the disposal of which leads to considerable additional costs. These disadvantages are particularly prevalent with self-compacting concrete because it contains additives of fine minerals. Consequently, relatively large quantities of superabsorbent polymer are needed in order to absorb the fine powders contained in the concrete. Another disadvantage consists in that said method cannot be used effectively with concrete that contains excess water to delay curing, since relatively large quantities of superabsorbent polymers are needed. In this case, a rather viscous, sticky gel forms which may result in the concrete mixture agglomerating.

JP 2009-126761 describes the use of a flocking agent in the form of a superabsorber as an additive for residual concrete, although this has the same deficiencies as were explained earlier with reference to JP 3147832.

Finally, WO 2012/084716 A1 describes a method for producing a granulate from residual concrete, in which a flash setting accelerator and a superabsorbent polymer are added to a cement composition so that setting with the flash setting accelerator causes a granulate to form. In WO 2012/084716, calcium aluminate hydrates having general structure (CaO.Al₂O₃) are suggested in particular as flash setting accelerators.

However, the method described in WO 2012/084716 also has a disadvantage in that the individual granules can stick to each other after the granulate produced has cured due to hardening with the flash setting accelerator, and must therefore be mechanically separated from each other before they are reused. The reason for this is that aluminum salts are used as the flash setting accelerator. Under the conditions that prevail during hardening, ettringite may form, which causes the granules to adhere to each other. This partial adhesion makes metering the granulate aggregates more difficult than is the case with a granulate in which the individual granules do not stick to each other.

In light of the situation as described above, there is a need for a method for recycling concrete that is no longer needed, which method delivers as an end product a granulate in which the individual granules do not stick to each other, so they can be metered relatively easily without the need to mechanically separate the granules beforehand. The present invention addresses this problem.

### DETAILED DESCRIPTION OF THE INVENTION

Accordingly, a first aspect of the present invention relates to a method for producing aggregates from non-hardened cement compositions, particularly non-hardened concrete or residual concrete, which comprises the addition of
a) a water-absorbing agent and
b) a crystallization deactivator to a non-hardened cement composition and mixing until a granular material has formed.

Surprisingly, it was found in this context that fresh concrete can be transformed synergistically into a granular material by the addition of a water-absorbing agent and a crystallization deactivator, in a concrete mixing truck for example, or a similar mixing device, thereby avoiding the disadvantages associated with the methods of the prior art. In particular, the specific combination of the water-absorbing agent and the crystallization deactivator forms a granular material, the individual granules of which do not stick to each other after they have completely cured, so that, compared with WO 2012/084716 for example, granulate aggregates do not have to be mechanically separated before the granulate can be used again. It was also found that the addition of the water-absorbing agent and the crystallization deactivator do not significantly impair the mechanical properties of the resulting granular material compared with the cement compositions which are hardened without these admixtures, so that the material has significant advantages over known concrete recycling products. The granular materials produced with the method according to the invention are thus characterized by particularly favorable properties and are usable in many application areas, for example in road construction or in making furniture, lightweight concrete or decorative applications.

The water-absorbing agent used in the method according to the invention is particularly a water-absorbing agent in the form of a superabsorbent polymer or in the form of a sheet silicate, sheet silicates in the form of vermiculite being particularly preferred.

The term “superabsorbent polymer” is used to refer to polymers that can absorb large quantities of water. When superabsorbent polymers come into contact with water, the water molecules diffuse into the voids in the polymer network, hydrating the polymer chains. This enables the polymer to swell to form a polymer gel or slowly dissolve. This step is reversible, whereby the superabsorbent polymers can be regenerated in their solid state by removing the water. The water absorption property is described by the swelling ratio, which refers to the ratio of the weight of a swollen superabsorbent polymer to its weight in the dry state. The swelling ratio is influenced by the degree of branching of the superabsorbent polymer, any existing crosslinking, the chemical structure of the monomers that make up the superabsorbent polymer's network, and external factors such as the pH value, ionic concentration of the solution and the temperature. Because of their ability to interact with water, superabsorbent polymers are also called hydrogels.

Examples of superabsorbent polymers that are usable within the scope of the present invention comprise natural polymers such as cellulose, chitosan or collagen, synthetic polymers such as poly(hydroxyethyl methacrylate), poly(ethylene glycol) or poly(ethylene oxide), or ionic synthetic polymers such as polyacrylic acid (PAA), polymethacrylic acid (PMAA), polyacrylamides (PAM) or polylactic acid (PLA), among others.

Superabsorbent polymers that are prepared from ionic monomers normally absorb more water than those prepared from neutral monomers, a property attributable to the electrostatic repulsion between the individual polymer chains. The degree of crosslinking corresponds to the number of chemical bonds. The higher the degree of crosslinking, and the greater the percentage of crosslinking agents, the shorter the distance is between two crosslinking points, which has the effect of reducing the degree of swelling. However, the degree of swelling also depends on external factors such as the pH value and the temperature. Superabsorbent polymers made from acidic monomers such as acrylic acid or methacrylic acid can be deprotonated at pH values above 7 to create negative charges in the polymer chains. The electrostatic repulsion associated with these causes a greater degree of swelling in alkaline media. Superabsorbent polymers that are particularly suitable within the scope of the present invention are ionic superabsorbent polymers, particularly those based on polyacrylamide modified with acrylic acid, and which may have either a linear or a crosslinked structure.

A second class of water-absorbing agents that can be used particularly advantageously as part of the method according to the invention are sheet silicates, particularly in the form of vermiculite. The term “vermiculite” denotes a sheet silicate which exists in the monoclinic crystal system having the general chemical composition Mg_{0.7}(Mg, Fe, Al)₆(SiAl)₈O₂₀(OH)_{4.}8 H₂O. Vermiculite develops flaky, scale-like or lumpy aggregates which are either colorless or colored gray-white, yellow-brown, gray-green or green by foreign admixtures.

The quantity of water-absorbing agent that yields particularly favorable results in the method according to the invention depends essentially on the water absorption capacity of the material used. Thus, superabsorbent polymers typically absorb more water than sheet silicates, so a small quantity of a superabsorbent polymer is sufficient to obtain a similar effect to that of a given quantity of sheet silicate. Within the scope of the method according to the invention, the superabsorbent polymer may advantageously be added in a quantity from 0.04 to 2% by weight, preferably 0.08 to 1% by weight, and most preferably 0.1 to 0.5% by weight relative to the total weight of the cement composition. In the case of sheet silicates, on the other hand, quantities in the range from 2 to 30% by weight, preferably in the range from 4 to 15% by weight, and most preferably in the range from 6 to 10% by weight are recommended.

In the course of the investigations relating to the present invention, it was demonstrated that the addition of vermiculite powder or of a superabsorbent polymer without the addition of a crystallization deactivator yielded a granulate of which the compactness was unsatisfactory after the materials had completely hardened. In contrast, significantly more satisfactory compactness characteristics were achieved when a crystallization deactivator was also added to the mixture.

In this context, particularly carboxylic acids having a molar mass<100 g/mol per acid group or a-hydroxycarboxylic acids have proven to be effective as crystallization deactivators. Particularly suitable, and therefore particularly preferred a-hydroxycarboxylic acids in the context of the method of the present invention are for example lactic acid, citric acid or maleic acid. Particularly suitable carboxylic acids having a molar mass<100 g/mol per acid group are for example oxalic acid, formic acid or acetic acid.

The quantity of the crystallization deactivator depends principally on the content of binding agent in the cement composition. In this context, quantities from 1 to 15% by weight, preferably 2 to 10% by weight, and most preferably about 3 to 8% by weight crystallization deactivator relative to the binder content in the cement composition have proven particularly suitable. It was also observed that a slightly larger quantity of crystallization deactivator is needed for hydroxycarboxylic acids, preferably in the range from 2 to 10% and particularly 3 to 8% by weight. In contrast, a slightly smaller quantity is sufficient in the case of carboxylic acids, and particularly dicarboxylic acids such as oxalic acid. Here, quantities in the range from 1 to 10% by weight and particularly 2 to 7% by weight have proven particularly suitable.

For the reasons explained earlier during the discussion of WO 2012/084716, preferably no calcium aluminate hydrates, and particularly preferably no aluminum salts are added in the method according to the invention, to avoid the formation of ettingite.

If the superabsorbent polymers or sheet silicates described previously are added to non-hardened cement, particularly liquid cement, they extract the water from the cement, and most of the water contained in the cement composition is absorbed into the superabsorber structure or the sheet silicate structure. This reaction has the effect of drying the residual concrete out and considerably reducing workability, even if excess water is present. A granular material is created by the rotation of a concrete mixer truck mixer or other mixing device.

Mixing time depends on the type of concrete and the measured quantities of additives added. Typically, a mixing time of about 5 to 10 minutes is sufficient to transform fresh concrete into a granulate, but longer mixing times may also be applied. This means that it is possible within the scope of the method according to the invention to add the water-absorbing agent and the crystallization deactivator to a concrete mixing truck mixer while it is still at the building site and produce a granular material while driving back to the concrete mixing plant. The granular material produced in the concrete mixing truck may then be discharged without delay upon arrival at the concrete mixing plant, leading to substantially increased productivity.

The granular materials according to the present invention may be stored in a relatively small space, and they harden completely in a short time. For example, granular materials that are left over at the end of a workday have hardened to such a degree after about 12 to 24 hours that they have sufficient mechanical strength to enable them to be transported to a storage area by a construction vehicle.

It is possible to add the water-absorbing agent and the crystallization deactivator to the cement composition separately or as a mixture. However, it is preferred within the scope of the present invention if in a first step a water-absorbing agent is added to the cement composition in a mixer and is then mixed together with the cement composition until a granulate has formed, and in a second step a crystallization deactivator is added to the mixture of cement composition and water-absorbing agent. It is then recommended to mix the crystallization deactivator with the mixture of cement composition and water-absorbing agent as well. In the first step, the water-absorbing agent initially removes a significant percentage of the water from the concrete, turning the concrete into a sticky, earth-moist granulate. In order to assist with this process, the mixing drum of a concrete mixing truck for example may be rotated rapidly for several minutes to ensure a homogenous distribution of the water-absorbing agent. Then, the crystallization deactivator is added and also thoroughly mixed with the granulate that has already been created from the cement composition and the water-absorbing agent.

It is possible to add further components to the cement composition within the scope of the method according to the invention. For example, additives which are customary for cement compositions, from the group comprising cement, cement setting accelerators, agents promoting the formation of aluminate hydrates, retarders, water insulating and water repelling agents, weathering inhibitors, slags, natural pozzolans, microsilica, fly ash, quartz sand, calcium carbonate, pigments and colorants, clay, porous hollow glass beads, plastic and rubber materials, may be added.

Agents for accelerating cement hardening contain for example calcium nitrate and sodium nitrate, calcium chloride and sodium chloride, triethanol amine, sodium thiocyanate and calcium silicate hydrates. However, other known means for accelerating the hydration of cement may be used within the scope of the method according to the invention. Agents for activating and forming aluminate hydrates are for example inorganic or organic soluble calcium compounds such as calcium hydroxide, calcium nitrate, calcium acetate, calcium formiate and calcium thiocyanate. Examples of hardening retarders are sodium gluconates and calcium gluconates, sucrose and other carbohydrates or carbohydrate derivates and citrates. Water insulating and water repelling agents contain organosilicone compounds such as silicones, silanes and siloxanes, colloidal and nanosilica and calcium stearate, but other substances may also be used with similar effects. The additives listed above may be formulated as a single product with the water-absorbing agent or the crystallization deactivator, or they may be added to the cement composition separately during mixing. Substances with a high content of amorphous silica, such as microsilica, and other natural or synthetic pozzolans may be added to improve the shelf life of the granular material of the present invention.

In order to confer the granulate prepared within the scope of the method according to the invention new properties for other valuable applications, particularly in the area of road construction and garden furniture construction, pigments or other colorants may added to the water-absorbing agent and the crystallization deactivator. For example, pigments based on iron, manganese, zinc or chromium oxides may be used to color the granular materials black, brown, red or green. Other colors and effects may be created by adding organic pigments that include fluorescing colorants. These may be used in the form of powders, pastes, a solution or a dispersion. The colored granulates obtained thereby can be used after they have fully hardened. In this way, granular materials with a particularly attractive appearance may be produced by appropriate selection of the type and the particle size distribution of the granulates of the cement mixture and white cement. These materials may be polished further and used as substitutes for natural stones in terrazzo floor coverings, for example.

Another possibility within the scope of the present invention is the production of lightweight aggregates by adding fine plastic or rubber materials to the fresh cement mixture. After the plastic or rubber materials have been worked into the concrete or concrete mixtures, the addition of the additives according to the present invention creates granular materials in which the plastic and rubber particles are fully embedded. Such aggregates are characterized by their low density compared with natural aggregates and may be used particularly advantageously to make lightweight concrete.

In a further aspect, the present invention relates to a cement granulate that may be prepared according to a method as described in the preceding text.

The present invention also relates to the use of a cement granulate such as described in the preceding text as an additive for cement compositions.

Yet another aspect of the present invention relates to an additive combination for cement compositions that comprises a water-absorbing agent and a crystallization deactivator. For particularly suitable water-absorbing agents and crystallization deactivators, the reader is referred to the preceding notes. In the context of the additive combination, it is preferred if the water-absorbing agent is present spatially separated from the crystallization deactivator. It is further particularly preferred if the water-absorbing agent is present in the form of vermiculite and the crystallization deactivator is present in the form of oxalic acid or lactic acid.

Finally, a further aspect of the present invention relates to the use of an additive combination as described previously to produce a granulate from a non-hardened cement composition, particularly from non-hardened concrete.

The production of granular materials according to the present invention and the properties of the resulting products as well as the use thereof will be illustrated in greater detail below with reference to several examples.

### EXAMPLE 1

A base mortar consisting of a mixture of 750 g Normo 4 [Siggenthal/Holcim AG], Vigier CEM I 42.5N [Vigier Ciment AG] and CEM I 42.5N [Wildegg/Jura cement] with a weight ratio of 1:1:1 and Blaine fineness according to EN 197-1 of 3600 cm²/g, 141 g limestone meal, 738 g sand having a particle size in the range from 0 to 1 mm, 1107 g sand having a particle size in the range from 1 to 4 mm and 1154 g sand having a particle size in the range from 4 to 8 mm was prepared in an A200 Hobart mixer. For this purpose, the sands, the limestone meal and the cement were mixed in the mixer for 1 minute, then the tempering water, in which the plasticizer (0.4 or 0.5% by weight, relative to the cement) was dissolved or dispersed was added, and mixing continued. The total wet mixing time lasted about 3 minutes each time. The resulting base mortar consistently had a flow diameter of 195-200 mm measured according to EN 1015-3.

A water-absorbing agent was added to this base mortar, and the mixture was mixed for 3 minutes in the Hobart mixer on mixing stage 2. Then, a crystallization deactivator was added and mixing continued for a further 3 minutes in the mixer on mixing stage 2. The compositions of the individual batches are listed in the following table 1.

TABLE 1

| | | Dosage rel. to | Ratio of water | Water incl. | | | | Compactness |
|---|---|---|---|---|---|---|---|---|
| Sample | Mixture | binder | to binder | mixture | Drying state | Pourability | Cleaning | after 24 h |
| 1 | VC-20HE | 0.5 | 0.42 | 315 | Good | Good | Good | Very good |
| | SAP | 0.12 | | | | | | |
| | Lactic acid (80%) | 5.00 | | | | | | |
| 2 | VC-20HE | 0.50 | 0.42 | 315 | Good | Good | Good | Very good |
| | SAP | 0.12 | | | | | | |
| | Oxalic acid | 4.00 | | | | | | |
| 3 | VC-20HE | 0.50 | 0.42 | 315 | Good | Good | Good | Very good |
| | Vermiculite powder | 8.00 | | | | | | |
| | Lactic acid (80%) | 5.00 | | | | | | |
| 4 | VC-20HE | 0.5 | 0.42 | 315 | Good | Good | Good | Very good |
| | Vermiculite powder | 8.00 | | | | | | |
| | Oxalic acid | 4.00 | | | | | | |
| 5 | VC-20HE | 0.4 | 0.4 | 300 | Good | Good | Good | Very good |
| | Vermiculite powder | 8.00 | | | | | | |
| | Lactic acid (80%) | 5.00 | | | | | | |
| 6 | VC-20HE | 0.4 | 0.4 | 300 | Good | Good | Good | Very good |
| | Vermiculite powder | 8.00 | | | | | | |
| | Oxalic acid | 3.00 | | | | | | |
| 7 | VC-20HE | 0.4 | 0.4 | 300 | Good | Good | Good | Very good |
| | Vermiculite powder | 8.00 | | | | | | |
| | Oxalic acid | 4.00 | | | | | | |
| 8 | VC-20HE | 0.4 | 0.4 | 300 | Good | Good | Good | Very good |
| | Vermiculite powder | 8.00 | | | | | | |
| | Oxalic acid | 5.00 | | | | | | |
| 9 | VC-20HE | 0.5 | 0.42 | 315 | Good (coarse) | Good | Good | Good |
| | Vermiculite powder | 8.00 | | | | | | |
| | Citric acid | 2.00 | | | | | | |
| 10 | VC-20HE | 0.50 | 0.42 | 315 | Good (coarse) | Good | Good | Good |
| | Vermiculite powder | 8.00 | | | | | | |
| | Citric acid | 3.00 | | | | | | |
| 11 | VC-20HE | 0.50 | 0.42 | 315 | Good | Good | Good | Good |
| | Vermiculite powder | 8.00 | | | | | | |
| | Citric acid | 4.00 | | | | | | |
| 12 | VC-20HE | 0.5 | 0.42 | 315 | Good | Good | Good | Good |
| | Vermiculite powder | 8.00 | | | | | | |
| | Maleic acid | 4.00 | | | | | | |
| V1 | VC-20HE | 0.4 | 0.4 | 300 | Good | Good | Good | Poor |
| | Vermiculite powder | 8.00 | | | | | | |
| V2 | VC-20HE | 0.5 | 0.4 | 300 | Good | Good | Good | Good |
| | SAP | 0.12 | | | | | | |
| | Al₂(SO₄)₃ × 14H₂O | 1.44 | | | | | | |
| V3 | VC-20HE | 0.4 | 0.4 | 300 | Good | Good (coarse) | Good | Average |
| | Vermiculite powder | 8.00 | | | | | | |
| | Al₂(SO₄)₃ × 14H₂O | 1.44 | | | | | | |

The resulting granulate was examined visually with reference to its pourability and drying state, and the residues in the mixing receptacle were evaluated. The mortar granulate was then emptied onto a heap and left to dry for 24 hours. The hardened mortar was then evaluated with respect to its compactness (compactness after 24 h). The following applies to the evaluation:

Drying state: Granulate that cannot be compacted and is only earth-moist at this time is evaluated as “good”.

Pourability: No coarse clumps or lumps clinging together is evaluated as “good”.

Cleaning: The mixing container empties completely, without any mortar residues, cement paste etc. remaining therein.

Compactness after 24 h: The mortar heap was evaluated with regard to adhesion among the particles. A compact mass to which force must be applied to enable subsequent granulation was evaluated as “poor”. If the dried mortar heap flows automatically, compactness was evaluated as “very good”. An evaluation of “good” was awarded if the mass was still intrinsically compact, but could be caused to flow with a slight application of force.

It was found the that the samples 1 to 8 according to the invention return comparable results to the sample V2 prepared according to WO 2012/084716 with regard to drying state, pourability and cleaning. In terms of compactness, however, all samples delivered better results than sample V2. The result for compactness of composition V1, to which only vermiculite was added, was very unsatisfactory, and could not even be improved significantly by the addition of aluminum sulfate (sample V3). Samples 9 to 12 also exhibited similar compactnesses to the comparison sample V2 despite not having been optimized.

### EXAMPLE 2

In order for it to be possible to reuse the recovered concrete granulate, it must have certain structural properties, which were examined in the following. In this context, sample 1 represents a concrete that contains no recycling material, whereas about 50% of the content of samples 2, 3 and 4 consisted of a granulate material with an admixture of 8% vermiculite powder and lactic acid (5%), oxalic acid (4%) or oxalic acid (3%). In these analyses, only a slightly changed curing time was noted for each of the compositions. Moreover, the concrete granulates registered only a slightly worse compressive strength achievable after curing for a day. The results of these examinations are presented in the following table 2.

TABLE 2

| | | Dosage | | | | |
|---|---|---|---|---|---|---|
| | | rel. to | Ratio of | Air | Compr. strength | |
| | | binder | water to | content | [MPa] 1 day | |
| Sample | Mixture | [%] | binder | [%] | absolute | Δ |
| 1 | 100% mix | 0.4 | 0.4 | 2.8 | 34.3 | |
| 2 | 50% gran- | 0.4 | 0.54 | 3.3 | 26.7 | −22% |
| | ulate with | | | | | |
| | 5% lactic | | | | | |
| | acid | | | | | |
| 3 | 50% gran- | 0.4 | 0.54 | 3.8 | 25.2 | −27% |
| | ulate with | | | | | |
| | 4% oxalic | | | | | |
| | acid | | | | | |
| 4 | 50% gran- | 0.4 | 0.4 | 4.0 | 26.8 | −22% |
| | ulate with | | | | | |
| | 3% oxalic | | | | | |
| | acid | | | | | |

1. A method for producing aggregates from fresh cement compositions comprising the addition of a) a water-absorbing agent and b) a crystallization deactivator to a non-hardened cement composition and mixing until a granular material has formed.

2. The method as claimed in claim 1, wherein a carboxylic acid having a molar mass<100 g/mol per acid group or an α-hydroxycarboxylic acid is used as the crystallization deactivator.

3. The method as claimed in claim 2, wherein the hydroxycarboxylic acid is supplied in the form of lactic acid, citric acid or maleic acid, and the carboxylic acid having a molar mass<100 g/mol per acid group is supplied in the form of oxalic acid, formic acid, or acetic acid.

4. The method as claimed in claim 1, wherein 1 to 15% weight crystallization deactivator relative to the binder content in the cement composition is added.

5. The method as claimed in claim 1, wherein a superabsorbent polymer or a sheet silicate is used as the water-absorbing agent.

6. The method as claimed in claim 5, wherein a superabsorbent polymer is added in a quantity from 0.04 to 2% by weight.

7. The method as claimed in claim 5, wherein a sheet silicate is added in a quantity from 2 to 20% by weight, weight.

8. The method as claimed in claim 1, wherein one or more additives selected from the group comprising cement, cement setting accelerators, agents promoting the formation of aluminate hydrates, retarders, water insulating and water repelling agents, weathering inhibitors, slags, natural pozzolans, microsilica, fly ash, quartz sand, calcium carbonate, pigments and colorants, clay, porous hollow glass beads, plastic and rubber materials is/are added to the cement composition.

9. The method as claimed in claim 1, wherein in a first step a water-absorbing agent is added to the cement composition in a mixer and is then mixed together with the cement composition until a granulate has formed, and in a second step a crystallization deactivator is added to the mixture of cement composition and water-absorbing agent.

10. The method as claimed in claim 9, wherein the cement composition is emptied out of the mixer after the water-absorbing agent and the crystallization deactivator have been mixed, and is dried until the cement has completely set.

11. A cement granulate which can be obtained in a method as claimed in claim 1.

12. The cement granulate as claimed in claim 11 is applied as an additive for cement compositions.

13. An additive combination for cement compositions comprising a water-absorbing agent and a crystallization deactivator.

14. The additive combination as claimed in claim 13, wherein the water-absorbing agent is present in the form of vermiculite and the crystallization deactivator is present in the form of oxalic acid or lactic acid.

15. The additive combination as claimed in claim 13 to produce a granulate from a non-hardened cement composition.
